(19) United States
(12) Patent Application Publication
(10) Pub. No.: US 2005/0114672 A1
(43) Pub. Date: May 26, 2005

(54) Data rights management of digital information in a portable software permission wrapper

(75) Inventors: David Duncan, Broomfield, CO (US); David A. Myers, Broomfield, CO (US)

Correspondence Address: J. Henry Muetterties, 7796 South Datura St., Littleton, CO, 80120, US

(73) Assignee: encryptX Corporation, Boulder, CO (US)

(21) Appl. No.: 10/718,417

(22) Filed: Nov. 20, 2003

(51) Int. Cl. H04K 1/00; H04L 9/00

(52) U.S. Cl. 713/182

(57) ABSTRACT

The present invention provides systems and methods for secure transaction management and electronic rights protection. The invention is a software permission control wrapper that is used to encrypt and encapsulate digital information for the purpose of enforcing discretionary access control rights to the data contained in the wrapper. The permission control wrapper enforces rules associated with users, and their rights to access the data. Those rights are based on deterministic security behavior of the permission wrapper based on embedded security policies and rules contained therein and that are based, in part, on the user type, network connectivity state, and the user environment in which the data is accessed.

### FIELD OF THE INVENTION

The present invention relates to the field of distribution, access and use of digital information, and in particular with data rights management of digital information which controls the distribution and unauthorized access and use of the digital information.

### BACKGROUND OF THE INVENTION

The use of sensitive digital information creates a real risk that the information will be used inappropriately, exploited, or even lost. There are several issues that anyone sharing sensitive digital information confronts; the protection of the digital information during transmission and after receipt thereof, and the unauthorized use of the digital information once received and/or shared with others.

The ability to create and share digital information makes businesses more productive, improves communication with internal and external stakeholders and creates operating efficiencies that can improve the bottom line. This has been the predominate set of reasons behind the vast amount of corporate dollars spent on information technology over the last two decades.

Digital information is only useful to a business in improving productivity if it can be shared. The ability to create and share digital information improves business processes, enables executives to make better strategic and tactical corporate decisions, enables front-line employees to make better decisions when dealing with customers, and can improve efficiencies in both the supply and demand chain sides of the business.

The need to share sensitive information both within and outside of a business poses a number of risks, especially when sharing competitive information, pricing information, manufacturing forecasts, financial information, technical specifications, etc. As businesses have moved to outsource more and more elements of their business and adopt more horizontally integrated business models, the need to share sensitive information outside of the corporate network has grown dramatically. And as the requirement to share sensitive information with internal and external users has increased, so to have the threats associated with those users that have access to the information. A recent survey (2002) by the Federal Bureau of Investigation and the Computer Security Institute revealed computer security breaches (including computer viruses) and thefts of corporate information are on the rise and the yearly cost per breach was increasing dramatically.

Security technologies today are categorized based on the different parts of the problem they solve, including: encryption, digital certificates, firewalls, anti-virus, biometrics, identity management, and intrusion detection and management. At their core these technologies provide corporations with part of the solution to either one of the two of the major security problems they face: loss of computing infrastructure due to denial of service and other types of virus attacks, and loss or misuse of sensitive corporate information due to unauthorized users gaining access to that information.

However, these types of systems are inherently weak in dealing with internally generated trusted user threats, as well as threats that are manifested by trusted users sharing with other “semi-trusted” users that may be inside or outside the enterprise. These weaknesses are characterized by the following:
Emphasizing protection of the network as a way to prevent access to the underlying data stored and used inside of the networks—rather than protecting the data itself.
Piecemeal protection of sensitive data—protecting data during transmission, through Secure Virtual Private Networks (SVPNs) and firewalls—but that do not protect the actual data when it has been received, and is in use on a remote employee or partner user PC.
Solutions that highly restrict sharing of sensitive information (using secure servers with web browser access or secure document management solutions) for the most critical pockets of sensitive information (e.g. financial department) within the enterprise but because of their cost are not widely implemented for all.

An annual survey conducted each year by CIO magazine (August 2003) has consistently shown that more than two thirds of a company's critical data is stored on users' PCs and laptops. Less than one third is controlled through a server. Similarly, more than two thirds of employees have access to sensitive information even though management thought less than one-third of those persons should have access. This distribution of sensitive information with users throughout the enterprise and with the individuals that they in turn share with creates the greatest risk to sensitive information disclosure and misuse.

A simple solution is to reduce the number of employees that have access to sensitive information, and lock sensitive data on servers that can be controlled. However, in order to realize productivity improvements from expenditures on Information Technology, businesses have continued to allow greater numbers of employees to access sensitive information in order to perform their jobs. This trend has grown dramatically, stimulated by the number and type of remote or telecommunicating workers, the use of outsourced partner companies in horizontally integrated business models, and the amount of information and decision making authority given to front line employees (e.g. sales, account management, customer service) that deal with customers and prospects. As a result of these trends, sensitive information is highly distributed, is in use on desktops and laptops, inside and outside of the firewall, with virtually no control.

What is needed is a method wherein a user or creator of sensitive information can protect the data on their PC, protect the data through the sharing or transmission process with other users, and most importantly, protect the data with digital rights management controls when it is in use on a recipients PC—without requiring the data to be hosted on a central control server. In effect, a distributed approach to digital rights management that uses a Peer to Peer approach as opposed to a server control approach, using secure data wrapping, labeling and encapsulation technology.

### SUMMARY OF THE INVENTION

The present invention includes an independent, portable software permission wrapper that allows the content provider (administrator) to control what the recipient (user) can do with sensitive digital information; such as making the read only, add, delete, modify, share with other users and the period of time in which the persistent content (digital information) can be accessed by the users. The permission control wrapper is used to encrypt and encapsulate digital information for the purpose of enforcing discretionary access control rights to the data contained in the wrapper. The permission control wrapper enforces rules associated with users, and their rights to access the data. Those rights are based on deterministic security behavior of the permission wrapper based on embedded security policies and rules contained therein and that are based, in part, on the user type, network connectivity state, and the user environment in which the data is accessed.

The content provider can place any type of content from their PC, file-server, or removable media into the permission wrapper and specify what users have access to the content, how they can access to the content, for how long and whether or not the user can share the content with third parties. The permission wrapper can be used to share data through multiple integrated secure sharing methods such as email, file server and removable media. The protected digital information is completely encapsulated and provides all functionality necessary for the recipient to open the files, use them and share them with others based on the permission granted to the recipient by the content provider, as well as dynamically change the level of access to the content based on the characteristics of the user and the environment in which the user is accessing the content.

### DESCRIPTION OF THE INVENTION

The application of the present invention provides a permission wrapping technology that securely wraps files, folders and/or directories. The permission wrapper provides the ability to provide different levels of access to the content to different users. When permitted, either the content provider (data originator) or the recipient may make modifications to the content within the archive. Currently, the only way to send the modifications is to resend the entire archive. Thus, the present invention provides the mechanism to allow a user to identify the point in time from which updates should be propagated. This point in time can be any time at which the archive was shared, or the time in which an archive was received by the user.

In the present invention, the permission wrapper travels with the persistent content (digital information) regardless of the platform, location or media on which the digital information resides. Since digital information is meant to be portable and is meant to be shared, it is important to have a digital rights management system which can be adapted to function regardless of the platform, location or media. Furthermore, users that receive the protected digital information do not require a software license to access the digital information or to share it with others. Hence, in its basic form, the present invention does not require a content administrative server to operate. In addition, administrative audit features allow the content provider to keep track of what was shared, with whom, what permissions were granted and for how long, and the users' names and passwords. These features ensure the content provider has accurate and up-to-date records on the access and use of the sensitive digital information.

The permission control wrapper automatically enforces user access to the data. The data contained therein is not accessible other than through interacting with the permission control wrapper. The permission wrapper is executable software and is functionally similar to a data archive used to store or backup data. The data archive is modified to function as a digital rights management security repository of digital information, such as files and folders of digital information.

The permission wrapper contains a series of control layers. Embedded in these layers are unique control files that interact together to construct a relationship between a user, their rights to access the file, the embedded features that control access to the data protected inside the permission control wrapper, control access to the content based on the user permission set, and audit user access to the permission wrapper.

The license layer next compares the user login to the user license to determine which control features are enabled or disabled. Licensed features include file operations (e.g. Copy) sharing operations (e.g. Email, Server, Hard Drive, etc.), permission control operations (describing and setting security policies for files and folders), audit operations and user operations.

As the user request for the file (typically a file open command) is processed, the permission wrapper first prompts the user for their authentication; such as digital certificate, biometric key, or user name and password.

The user identification information is then compared to the access control list maintained in the permission layer of the wrapper. The permission layer retains a liste of the users, their permission assignments and the grantor of those assignments. The comparison of the user login information and the access control list defines the controls which are enacted in subsequent layers of the permission wrapper.

The actual sensitive contents (files and folders) of the archive are maintained in an encrypted layer. Upon an accepted login, and after comparing the user to their license, a descriptive listing of the contents is then displayed to the user, along with the management user interface. Only the files and folders that the user is granted access to are displayed. Files and folders that the user does not have access to remain hidden from the user and are not displayed. Features of the user interface that the user is licensed for are accessible. Features that the user is not licensed for are not accessible.

The user may then decrypt, open or further share protected files and folders in keeping with the users allowable permissions. The permission structure is automatically maintained and an inheritance model is associated with that user. Hence, any new users that an authorized user adds to the archive may have permissions no greater than the user that created him or her, and permissions may be further restricted below the level of the original authorized user.

The permission control wrapper is portable. A user accessing files and folders in the permission wrapper may share the entire wrapper and all, or selected files and folders to other users based on his or her allowable permissions. When the permission control wrapper is shared, the recipient receives the files in the permission control wrapper, which is installed on the user's computer or digital storage media. Subsequent sharing operations continue to maintain the state of the permission control operations, and the internal user access list and audit trail is updated with new information. This new information can be reported back to a central audit server log through a communication protocol.

The permission control wrapper is self-executing. The user may not access files and folders outside the permission control wrapper without an allowable permission setting that gives the user decrypt or Save As permission. When the user attempts to access files and folders in the permission wrapper, they must interact with the permission wrapper itself. They may not access the files indirectly, using operating system open, view, read, send to and copy commands.

The permission control wrapper enables many user roles using the same set of sensitive digital information. An unlimited number of users can be authorized to access the contents of the permission control wrapper. Each user can be assigned a completely different set of access rights. For some users, files and folders may be hidden, while other users can see those hidden files and folders. Certain users may only have read only permission with no sharing capability, while other users have native Save As permission and can share with others.

The permission control wrapper has an embedded data locking feature. The permission wrapper can be bound or locked to a particular user PC, file server, or group of computers. A unique identification and enrollment application process is provided wherein authorized users run the application process and it in turn creates a unique hashed identifier for that machine. The hashed identifier is maintained in the user system registry. When the data in the permission wrapper is shared with the user, it compares the user login and determines if the user permissions require locked or fixed access. If the fixed access permission is identified, the user may only access and open contents of the permission wrapper on that computer or device. If the user attempts to use the permission wrapped data on another computer (e.g. if the data is on a CD or DVD and the user inserts the CD or DVD into another PC),

The permission control wrapper understands the network connectivity state of the user and the state is used to determine the permission control settings for that user. The permission control wrapper includes an application process that periodically pings the user network identification card (NIC) to determine if a network connection is present.

The permission control wrapper has an embedded audit trail that maintains event log information on user actions and behavior and has embedded secure data sharing controls.

The permission control wrapper can recognize threats to data and can automatically change the permission controls based on the recognition of threats to data.

The present invention provides a method of aggregating any set of files, folders and directories. This aggregation within the permission wrapper, is protected through encryption, provides discretionary access control, and a number of means by which the archive can be shared with others.

The present invention includes the ability of an enterprise to track and create reports on the use of their sensitive content that it is protecting, the users of the content and their respective permissions, what digital information the users are sharing, and with whom, and which versions of the digital information are being shared with others. In addition, the present invention allows the tracking of how each user interacted with the digital information, such as opening, decrypting, viewing, creating users, setting privileges and their sharing operations.

The present invention is aimed at solving the problem of ensuring that sensitive corporate information is not lost or misused by different internal and external users of that information. This approach has at its core several fundamental assumptions:
that digital information is inherently portable,
that digital information will be shared with different users,
that those users will or should have different rights to the information based on their role and need,
that the protection mechanism should be continuous (e.g. protect the data locally, during transmission, and when in use on the recipients machine),
that the protection mechanism should be able to enforce user roles,
that the protection mechanism should have the ability to audit and report individual access violations to the data, and
that in the future the encapsulation protection mechanism should adopt a “policy-driven” approach to protecting the sensitive information based on recognition and understanding of the threat posed by the environment in which the data is being used.
The permission control wrapper is self-executing,
The permission control wrapper can hide or mask files

The present invention allows the content provider to specify as much or as little security protection as the owner of the information requires. Using a variable security model, the owner can simply encrypt and assign passwords, or add unique discretionary access rights at the aggregated content level, or add even further unique rights on individual files and folders.

The present invention is designed to address the security problems associated with removable storage media, such as floppy disks or CD-ROM discs. Removable storage media is easily stolen or misplaced. The secure data storage application 102 for removable media can also be used in as a plug-in to the basic secure data storage application, and is designed to ensure that information stored on such media is protected if such media is in fact stolen or misplaced. The application is a high-speed, block encryption application that is written on the removable media. This small encryption application takes up minimal space on the media, supports variable key lengths in order to comply with US export restrictions, and based on testing conducted by the National Security Agency that is certified appropriate for commercial use.

Additionally, the present invention allows the user to create HTML content on a secure data storage media. The secure data storage application launches automatically the client browser and after the user enters the correct password, they can navigate the contents of the disc. The HTML content is decrypted on the fly and the user does not need to copy any of the information onto the hard drive.

This feature is especially useful for individuals that need access to web content in an offline manner, yet that still protects the contents. Examples include field service technicians that require access to product manuals and diagnostic information that has been organized in a web directory format, workgroup files (e.g. Lotus Notes) or any type of information that is more easily navigated through a browser interface.

The present invention is also designed to provide a mechanism to encapsulate sensitive information for transmission as an email attachment over the Internet, and to maintain the security protection envelope and policy management scheme after it has been downloaded to the recipient's hard drive or file server. In addition, when use in conjunction with email, the sender receives a “certified mail receipt” notifying them of the receipt of the archive 100 by the user. The secure data storage application ensures that sensitive information that a user sends over the Internet is protected from attack and minimizes the potential impact of known email software security holes. Since each email attachment is wrapped in a “protected and intelligent” envelope, the information contained in the email is itself uniquely protected, providing an additional layer of protection beyond browser based security software. After the email attachment is opened, our software automatically installs a protected archive of information on any system that the user specifies. The sender controls how long the information can be used and the permissions associated with accessing the information. Finally, an automatic email notification is sent to the sender, providing a “certified mail receipt” that informs the sender that the information was successfully received, is installed on the recipient's machine, and captures the machine name where the information is stored.

One feature of the present invention functions as an active index and catalog that keeps track of secure sharing form PC desktop to PC desktop, or to and from a file server. The secure data storage application is essentially a Systems Security Officer/Administrator reporting tool that can be server based and that track where sensitive information is stored (either on the hard drive, the file server, or on removable media), with whom the information has been shared, and the access control policy associated with the information. Another feature of the present invention functions to provide audit tracing and reports on the sensitive information created, managed, used, and distributed by a business. The software will be capable of recording all I/O activity associated with sensitive business information, provide automatic alerts if sensitive information is not being effectively protected or if actions that violate access control policy are attempted by users, and will provide reports regarding the general status, use, access, and distribution of sensitive information by a business.

The present invention discloses a permission control wrapper that is portable, self-executing, can hide or mask files, has embedded security permission controls, secure data sharing controls, and a data locking feature. Furthermore, the permission control wrapper of the present invention understands the network connectivity state of the user. In addition, the present invention can recognize threats to data and can automatically change the permission controls based on the recognition of threats to data.

Lastly, the permission control wrapper of the present invention has an embedded audit trail that maintains event log information on user actions and behavior and a component that tracks attempts to violate security policies and provides notification of a potential problem.

### BRIEF DESCRIPTION OF THE DRAWINGS

FIG. 1 is a schematic of the secure container of digital information of the present invention.

FIG. 2 is a schematic of the basic control layers of the permission wrapper.

FIG. 3 is a diagram of the content portion of the permission wrapper having multiple types of content in the form of digital information that may be placed into the archive by the content provider.

FIG. 4 is a schematic of the control access rules (permissions) within the metadata portion of the permission wrapper of the present invention.

FIG. 5 is a schematic of the application of the present invention to an electronic appliance.

FIG. 6 is a schematic of the methods of sharing the protected content as contemplated by the present invention.

FIG. 7 shows the access controls of the permission wrapper used to control access to the content within the archive.

FIG. 8 shows an example of a server based electronic information system of the present invention.

FIG. 9 is a diagram of the user permissions, license, network connectivity state and environmental state that define the status of users.

FIG. 10 shows the use of present invention in conjunction with a removable media containing Web-based content.

### DETAILED DESCRIPTION OF THE INVENTION

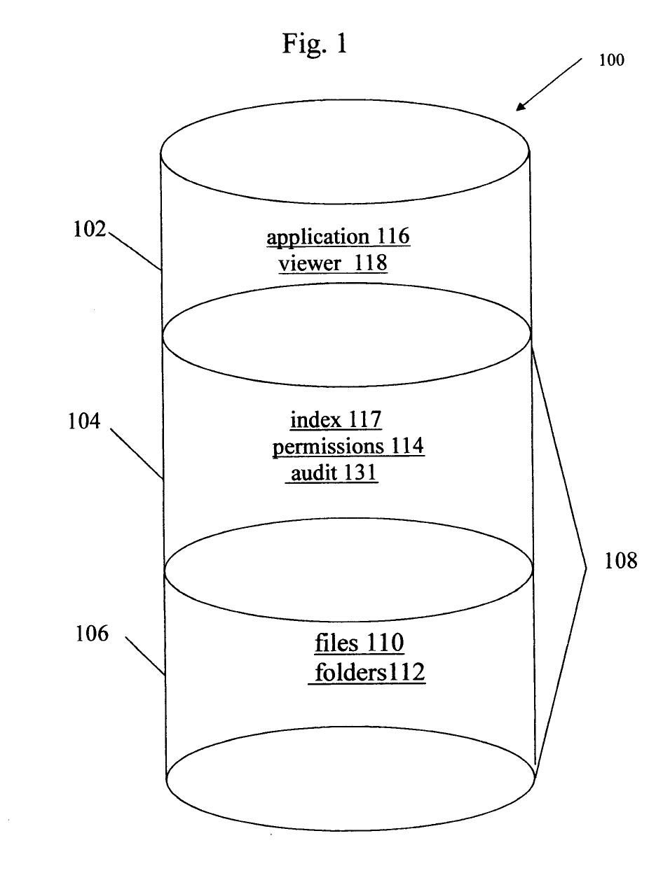

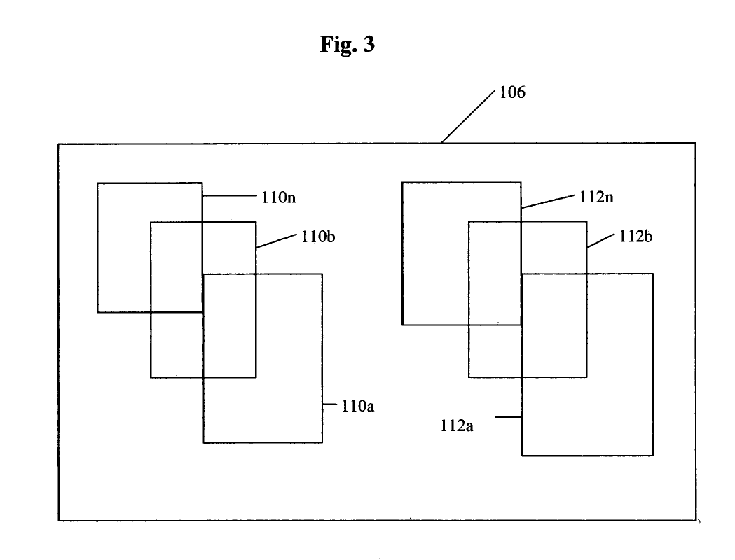

FIG. 1 shows the secure container or archive 100 of the present invention including a software application portion 102, a metadata portion 104 and a content portion 106. The application portion 102 and metadata portion 104 define the portable, independent permission wrapper 108 of the present invention. The application portion 102 includes all applications necessary to access the content 106, typically digital information, contained in the archive 100. The applications include the executable applications software 116 as well as the viewer 118. Within the metadata portion 104 the content provider places an index 117 including user(s) identifying information, file size, time limits, audit functions and version control and permissions 114 as discussed below. The content or data 106 is the digital information to be protected, which can be in any type of format. The content portion 106 is the aggregation of the files 110 and/or folders 112. As shown in FIG. 3, the content 106 can have any number of files 110a, 110b, . . . , 110n and/or folders 112a, 112b, . . . , 112n. Both, the metadata portion and the content, 104 and 106 respectively, are encrypted. An encryption engine which works well within the present invention is Blowfish, though any number of encryption engines can be used. Access to the secure archive 100 is associated with individual users. Users can be identified by a user name and password, or through other means such as a biometric or a PKI certificate.

The permission control wrapper 108 can be used to provide permission control over all types of digital information, including: movie files, spreadsheets, music files, word processing files, database files, other types of entertainment content, presentations, and any other type of information that is stored in digital form.

The permission control wrapper 108 can be created on any type of digital media including on PC hard drives, file server drives, disk arrays, Personal Digital Assistants (PDAs), recordable and rewritable CD and DVDs, Zip® drives, tape storage devices, and all other types of computer media that can be written to.

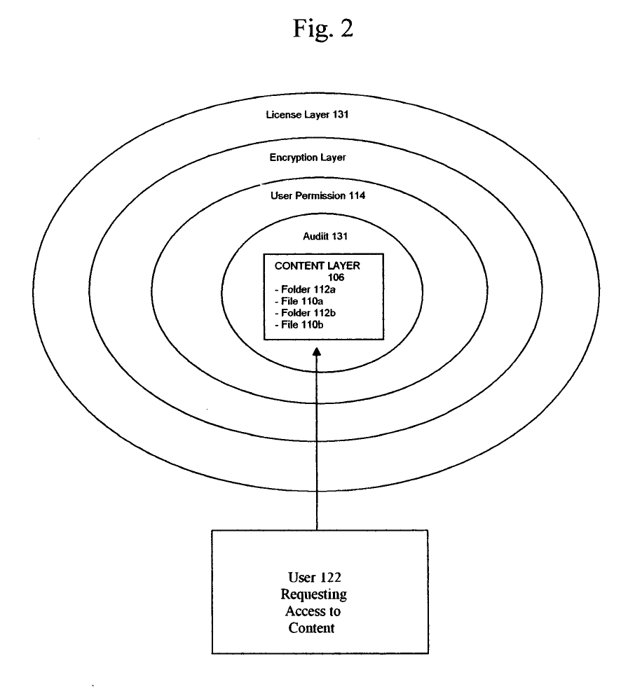

FIG. 2 shows a schematic of the control layers of the permission wrapper 108 of the present invention. It shows that the permissions 114 and data portion 104 are within the encrypted portion of the archive 100. Before a user 122 gains access to the protected content, it must first be determined that they have a license to access the content 106 before the permission wrapper 108 determines they have the requisite permissions to access the content 106.

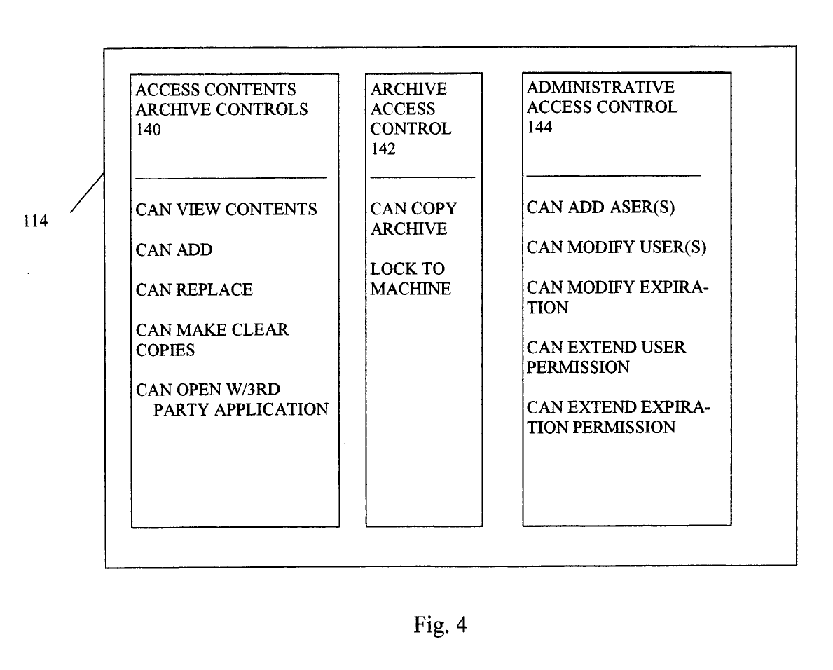

As shown in FIG. 4, the secure data storage application 102 has three basic types of access control rules:
Archive contents access control 140 determines the way in which you can limit or grant access to individual archive folders and files for each user.
Archive access control 142 determines the operations that can be applied to the encrypted archive as a whole for each user.
Administrative access control 144 includes setting up new users and determining the set of access control rules that they can configure for other users.

The Archive Contents Access Control has four distinct permissions or rules: Can View Contents 1126, Can Add 128, Can Replace 130 and Can Make Clear Copy 132. Each of these rules can be applied to the archive 100 or content 106 as a whole, to files 110, folders 112, or directories 114 within the archive 100. A rule applied to the archive 100 applies to all of the files, folders and directories in the archive 100. This rule would be applied at the root directory. A rule applied to a directory 114 applies to the directory and recursively to its contents. A rule applied to a file 110 applies only to that file 110. A rule can grant additional permissions or revoke permissions granted at a higher level. A user cannot be granted more liberal permissions than those held by the user who granted them access. This means that new permissions cannot be added and existing permissions cannot be removed if they would grant permissions to a user that are not held by the grantor.

The user downloads the installation file or uses an installation disc to install the software. When the installation process is successful, one can use the solution to create an encrypted archive, or manipulate existing archives. After the user has installed the secure data storage application on their electronic appliance 126 they can perform the basic functions of the application. The user 122 opens the application window and encrypts the content 106s they want to protect. Once the files have been added to the archive 100, the user 122 can perform the basic operations of viewing a list of the files, opening the files, decrypting the files, deleting the files, and/or copying an archive on removable storage media 128 to a hard drive, sharing an archive to removable media (if you have the media plug-in), and perform other sharing operations.

The Can View Contents permission controls whether an archive 100 can be displayed in the Decrypt or Contents dialogs. Contents 106 without the Can View Contents permission are effectively treated as not being in the archive 100. Application of the Can Add permission controls whether additional files and folders can be added to an archive 100. This rule can be applied to the archive 100 as a whole (Can Add to Archive permission) or to individual files 110 and folders 112 (Can Write permission). The Can Replace permission controls whether existing content 106 can be replaced or removed within an archive 100. This permission can be applied to the archive 100 as a whole or to individual files 110 and folders 112 (Can Overwrite permission). Lastly, the Can Make Clear Copy permission controls whether the files 110 and folders 112 can be decrypted and clear copies of the files placed outside the archive 100. The Can Make Clear Copy permission can be applied to the archive 100 as a whole (Allow Decrypt and Open vs. View Read-Only permission) or to individual files 110 or folders 112 (Can Decrypt/Open permission).

The Archive Access Control rule 142 contains the permissions that apply to the archive 100 as a whole. The Can Copy Archive controls whether a user 122 is allowed to copy the archive 100 to another location on a fixed disk on their local machine. The application software GUI 130 implements this by enabling or disabling the Can Copy Archive operation.

The Administration Access Control 144 type of access control contains rules that can be applied to users 122 other than the original administrator user. These rules are; Can Add User(s), Can Modify User(s), Can Modify Expiration, Can Extend User Permission and Can Extend Expiration Permission. A user with the Can Add User permission can add new users who have access to the archive 100. The permissions or privileges accorded the new user are restricted by the set of permissions or privileges granted to the original user or administrative user performing this operation. The explicit restrictions on the access to the content 106 can be manipulated by the new user and are exactly the same restrictions as those imposed on the creating or administrative user. After creating a new user, the creating user can place additional restrictions on the new user's access to the archive 100. The permissions or privileges that the creating user must have and privileges granted are discussed in greater detail below.

A user 122 with the Can Modify User permission can modify existing users within the archive 100. This user 122 can change another user's password or they can grant or revoke any of the privileges listed under the Can Add User permission with the same restrictions listed under that rule. A user can not modify their own privileges, nor can any user modify the privileges of the administrator or content provider 120 who created the archive 100. The Can Modify User permission permits the user to alter the content permissions associated with another user. The grantor can add or revoke permissions as long as the permissions don't allow access to the content 106 to which they lack permission.

The Can Modify Expiration privilege can change the archive expiration date for another user. If the archive 100 does not have an expiration date for the granting user, then the granting user can set the modified user's archive expiration date to “Never” or to any designated expiration time. If there is an archive expiration date for the granting user, then the grantor cannot set the expiration to “never” or to any date later than the grantor's expiration date.

A user with the Can Extend User Permission privilege can create or modify users of the archive 100 and give those users the Can Add Users, Can Modify Users, and Can Extend User Permissions privileges (assuming the user has those privileges to begin with).

With the Can Extend Expiration Permissions privilege, the user can create or modify users of the archive 100 and give those users the Can Modify Expiration and Can Extend Expiration Permission privileges (assming the user has those privileges to begin with).

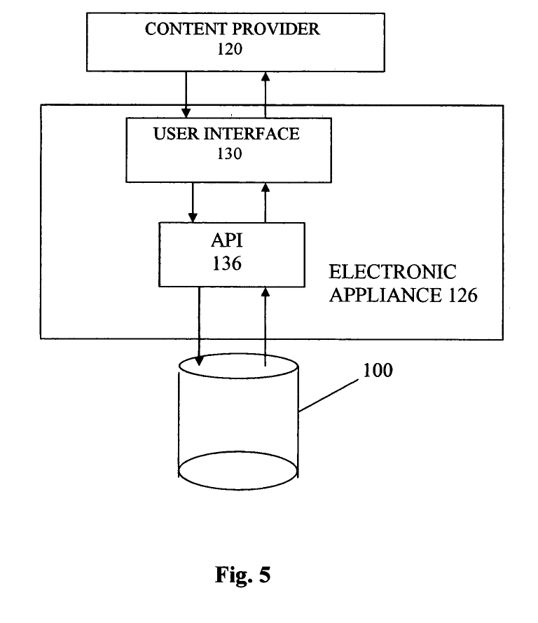

As shown in FIG. 5, the secure data storage application 116 is written to an electronic appliance 126, which can be a PC, file server or the like. Once the secure data storage solution has been added to the appliance 126, the content provider 120 creates the encrypted archive 100 on the hard drive, file server or piece of removable storage media 128. To protect the sensitive files, the content provider 120 adds them to the archive 100. Encrypted archives 100 on a hard drive or on a file server function identically.

The permission control wrapper 108 has embedded control features that provide the user 122 with access to the content 106 and the ability to perform operations on the protected content 106 through a user interface 130. These control features are managed through a software license key 131 (described in detail below) associated with the application 116 that automatically allows or disallows user access to user interface 130 control features that manage access to the archive. User interface features controlled through the license key include:
a) User operations, which provides the ability to assign users to the content in the archive, and assigning those users their individual or group permission controls.
b) Sharing operations, which provides the ability of the user 122 to share content 106 maintained in the archive 100 through protected email, on all types of computer removable storage media 128, on hard drives and on file servers.
c) Encryption operations, which provides the ability of the user 122 to add files 110 and folders 112 to the permission wrapper 108 in an encrypted form.
d) Decryption operations, which provide the ability of the user 122 to decrypt files 110 from the archive 100 and store them outside of the archive on all types of digital storage media, such as hard drives, computer removable storage media 128, disk arrays, etc.
e) Audit operations, which provide the ability to recover user names and passwords, and access an event log of information maintained for the permission wrapper 108 that tracks which users 122 have access to the content 106, the type of access they are granted, when they were granted access to the content, on what devices are they allowed to access the content 126, the users that they in turn shared content with, and what operations the users have performed on protected files and folders maintained in the archive.
f) Locking operations, which provide the ability to lock or fix the content 106 in the archive 100 to a machine 126, device or related group of machines and devices.
g) Synchronization operations, which provide the ability to version control, update and synchronize files 110 and folders 112 with new information, and in turn to share those updates to other users that also have been granted access to the content 106 through sharing operations.
h) View operations, which provide the ability to see the files 110 and folders 112 stored in the archive 100.

The permission control wrapper 108 provides users with secure sharing methods controlled functionally by the permission wrapper and accessed through the user interface 130. Secure sharing methods ensure that the content 106 remains in protected form not only during the actual sharing operation, but also when the content 106 is installed and in use on a recipient's PC 126. Secure sharing features include email, PDA, hard drive, file server, instant messaging, and all forms of PC removable storage media (e.g. DVD, CD, floppy, USB flash drives, etc.)

The permission control wrapper 108 maintains version history of when files 110 and folders 112 have been added to the archive. The version history includes all versions of files wherein the recognition of the latest version is based on the date stamp of the file assigned by the operating system. An incremental update feature is provided by which a user 122 may share only new or changed files with users that have access to protected files in the archive. Such incremental update feature allows the user to only send the changed files, rather than all of the files in the archive. A synchronization feature is also provided by which a user may notify other users of shared archives that a file or folder has changed, and those users may in turn receive only the updated or changed files or folders for shared content protected on their machines.

The permission control wrapper 108 maintains an audit trail of information regarding user activity. The audit trail information is maintained internal to the permission wrapper and can be retrieved by the archive Administrator or other users that are granted audit permission. Audit information includes such information as what users have been granted access to protected files in the archive, the type of access granted and their permission settings, the user password and login, user sharing operations on protected files, the users that protected files have been shared with, file versioning and update operations, user machine identification information, and a descriptive list of which files and folders the user has been granted access to.

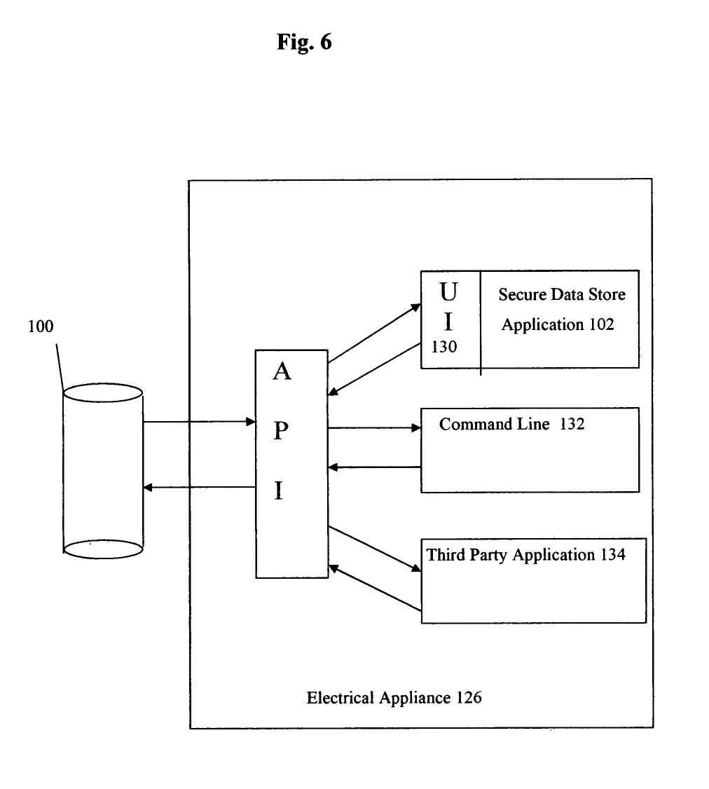

The permission control wrapper 108 is a self-executing security control construct used to protect digital files and folders maintained therein. As shown in FIG. 6, access management and control features are accessible through three different mechanisms. The first is a graphical user interface 130 that displays when the user successfully authenticates him/her through either a symmetric or asymmetric key login to the permission control wrapper. The graphical user interface 130 provides the user accessing files in the permission control wrapper 108 with all the functionality necessary to use files, share files, and add other users to the protected files. The second access mechanism is through a command line interface 132 that can be used to create and distribute large numbers of files and folders to large numbers of users. The command line interface 132 is typically used in batch, or volume, operations, and can be invoked through third party software applications, such as CD or DVD mastering programs. The third access mechanism allows third party applications 134 to integrate archive access using a software application programming interface (API) 136. The API provides other software applications with an embedded ability to write files to the permission control wrapper 108, set the policies and rules for those files and to assign users and their permissions 114 for those files.

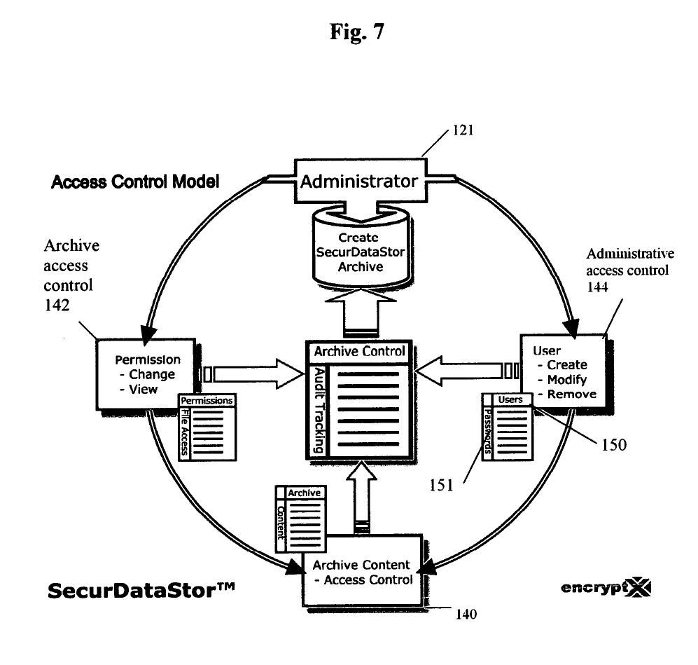

FIG. 7 shows (moving clockwise from the 12 o'clock position) that the administrator or content provider 120 can apply multiple levels of control to the content 106 contained in the archive 100. For purposes of this disclosure, it is understood that the administrator and the content provider could be two separate individuals wherein the content provider places the content into the archive 100 and the administrator and the users 122 and their respective permissions 114 would be established by the administrator. At the basic level (3 o'clock position), the content provider 120 can choose just to encrypt and assign users and passwords. At the next level (6 o'clock position) the content provide 120 can apply a number of very powerful access control policies 140, 142, and 144 to all contents 106 of the archive 100, in the aggregate (e.g. Copy, Modify, Delete, Time Expiration, Can Share with Others, etc.). If the content provider 120 wants to provide even more security (9 o'clock position), they can assign unique file 110 and folder 112 level access control permissions, and can even restrict or hide certain content 106 from view, or can make certain files 110 or folders 112 Read Only, so that those files 110 of folders 112 can only be viewed through the restricted viewers 118; disabling the user's ability to cut, paste, print or copy the content 106.

As shown in FIG. 7, the administrator or content provider 120 placing the digital information content 106 within the permission wrapper 108 can provide multi-level permission to the files 110 and/or folders 112 within the archive 100 For example; file 110a may be viewed, printed and/or edited, while file 110b can only be viewed by the recipient. Additionally, the existence of any file 110c can be hidden from the receiver(s) altogether. This is of particular importance when the content provider 120 transmits the container 100 to a first receiver or user 122 who has been authorized to view the contents of item 110a but the existence of item 110c can not be disclosed to recipients 222 downstream of the first recipient 122. In the case of the sale of multi-media and/or sound recordings, the content provider is the distributor of the digital information or content 106.

The Administrator user 120 creates an encrypted archive 100 and adds files 110 and folders 112 to it. The Administrator user 120 adds a new user 122 by:
a. Entering a user name and password for them, or providing an alternate form of identification such as a biometric or a digital certificate.
b. Selecting the operations that they can perform on the archive 100 (such as viewing the archive contents, adding files to the archive, copying the archive, etc.).
c. Selecting the administrative privileges 144 for them (such as the ability to create new users, modify the expiration date for users, etc.).
d. Determining if they can decrypt files 110 or only view them. (When you restrict viewing of the files, for selected file types, the new user can view the files, but not print or save them. The user also cannot copy data from the files, or make any changes to them. They also cannot decrypt the files to make a local clear copy of the files.)
e. Defining a limited time period for access to the archive, if desired.

Optionally, after adding the new user 122, the Administrator user 120 defines the new user's permissions (ability to view, decrypt, encrypt files, etc.) for specific files 110 and folders 112. A content provider 120 can always skip specifying the user's permissions for individual files 110 and folders 112, and let their permissions 114 for the archive 100 as a whole define their permissions 114 for all files 110 and folders 112. Alternatively, the content provider 120 can give new users 122 their own Administrator user name 150 and password 151 as well as the archive encryption key phrase. The new users 122 can then login as the Administrator user. As the Administrator user, they will have complete access to the archive 100 and all administrator functions, including unrestricted ability to define access control permissions.

Secure Data Storage Permissions

For each user, most secure data storage application permissions 114 can be defined both for the archive 100 as a whole, and for and individual files 110 and folders 112. The permissions 114 pertain to administrative access control 144.

For a more complete description of secure data storage application permissions 114, see the following table.

TABLE 1
Secure data storage application permissions

| Permission | Functionality | Access control rule type |
|---|---|---|
| Can view | Can view archive contents | Archive access control |
| contents | with the contents viewing, | Archive contents access |
| | decrypting, and changing | control |
| | permissions dialog boxes. | |
| Can add to | Can encrypt folders and | Archive access control |
| archive | files to archives. | Archive contents access |
| | | control |
| Can replace | Can replace folders and | Archive access control |
| and delete | files in archives by | Archive contents access |
| | adding ones with the same | control |
| | names and locations, thus | |
| | overwriting the originals. | |
| | Also, can delete archive | |
| | folders and files. | |
| Can copy | Can copy archives from | Archive access control |
| archive | removable storage media to | only |
| | local hard drives. | |
| Can share | Can share archives by | Archive access control |
| | emailing them, copying | only |
| | them to local hard or | |
| | networked drive locations | |
| | or to removable storage | |
| | media, and by adding | |
| | encrypted Web content to | |
| | removable storage media. | |
| Allow decrypt | Can decrypt directories | Archive access control |
| and open | and files in archive. | Archive contents access |
| | | control |
| View with | Cannot decrypt files. Can | Archive access control |
| read-only | only view files in the | Archive contents access |
| viewer | restricted read-only mode. | control |
| Can add users | Can add users to the | Administrative access |
| | archive. | control |
| Can modify | Can change the | Administrative access |
| users | administrative and archive | control |
| | contents permissions for | |
| | users. | |
| Can modify | Can change the archive | Administrative access |
| expiration | expiration date users. | control |
| Can extend user | Can give users the ability | Administrative access |
| permissions | to extend permissions, | control |
| | such as to add and modify | |
| | additional users, to other | |
| | users. | |
| Can extend | Can enable users to give | Administrative access |
| expiration | other users the ability to | control |
| permissions | modify the expiration date. | |

TABLE 2
Requirements to add or to remove a permission

| Desired permission | Necessary prerequisite |
|---|---|
| Can view contents | Can modify users, Can view contents |
| Can add to | Can modify users, Can add to archive |
| archive (encrypt) | |
| Allow decrypt | Can modify users, Allow decrypt and open |
| and open | |
| Can replace | Can modify users, Can replace and delete |
| and delete | |
| Can copy archive | Can modify users, Can copy archive |
| Can share | A licensed version of Secure data storage |
| | application installed on the user's PC |
| | that supports sharing |
| View with | Can modify users |
| read-only viewer | |
| Can add users | Can modify users, Can extend user permissions |
| Can modify users | Can modify users, Can extend user permissions |
| Can modify | Can modify users, Can extend expiration |
| expiration | permissions |
| Can extend | Can modify users, Can extend user permissions |
| user permissions | |
| Can extend | Can modify users, Can extend expiration |
| expiration | permissions |
| permissions | |

The administrative access control rules 144 are used to manage the permissions 114 for all users 122 and 222 of an encrypted archive 100, except for those of the Administrator user 120. Through administrative access control 144, depending on one's permissions, you can: Add new users to the archive, Modify user information, Remove users from the archive, and change user passwords.

The creator of the archive is automatically designated the Administrator user 120 and has all permissions 114 for the archive 100. As such, their permissions never expire and cannot be restricted. In addition, as the administrator user 120 you can add other users and specify the operations that they can perform. Administrative access control operations 144 include giving administrative privileges to other users, setting an expiration date for access to the archive, and modifying all user permissions.

After a new user 122 has been added, anyone with the permission to modify user information can redefine the scope of that user's activities. However, if a user doesn't have a specific permission 114, they cannot add or remove that permission from another user. Because the Administrator user 120 doesn't have any restrictions, if other users have problems with the way their permissions have been set up, the Administrator user can fix them.

A user 122 cannot modify their own permissions 114. When adding or modifying other users, they cannot grant more liberal permissions than those they have themselves. However, if they can modify user permissions, they can further restrict permissions for other users or grant permissions to those users which the grantor has but the grantee does not.

For instance, if a user/recipient 122 might have the permission to create new users, view the contents of the encrypted archive, and to copy the archive, but not to add files to the archive. When that user creates a new user 222, the user 122 can give them permission to view the archive contents 106 and copy the archive 100, but cannot give them permission to add files to the archive. But if the user/recipient 122 only wants the secondary recipient 222 to be able to view the contents, user 122 can choose not to activate permission for them to copy the archive.

Whenever a new user is created, the new user initially has the same permissions that the creator has. For example, if the creator of a new user has specific permissions for selected individual files 110 and folders 112, the new user inherits the same permissions 114 for those particular files 110 and folders 112. If the permissions 114 for the selected individual files 110 and folders 112 do not match the user's overall archive permissions, you can modify these permissions after you finish adding the new user to the archive 100.

For guidelines for adding and modifying users, see the below table.

TABLE 3
Guidelines for adding and modifying users.

| General | Add user | Modify user |
|---|---|---|
| Administrator user created | Must give a unique user | Can only modify permissions |
| when archive created. | name. | for other users. |
| Archive creator is | Password doesn't have to be | Cannot modify own or |
| automatically designated the | unique. | Administrator user's |
| Administrator user. | | permissions. |
| Administrator user always | New user initially has access | Can view folder and |
| has full permissions and can | to identical permissions as | individual file level |
| give full permissions. | creator, though creator must | permissions for other users. |
| Administrator user is never | select available permissions | Can change permissions for |
| restricted from the archive | to activate them. | other users on the folder and |
| except when they cannot | | individual file level. |
| access the archive because | | |
| they haven't licensed Secure | | |
| data storage application | | |
| before the trial period | | |
| expired. | | |
| Cannot add a permission that | Creator can restrict the | Can change passwords for |
| one doesn't have when | permissions of the new user | other users. |
| adding or modifying a user. | by not activating them. | |
| As long as one isn't adding | If the creator doesn't have | Can remove other users. |
| or removing permissions that | permission to perform an | |
| one doesn't have, can restrict | operation, new user also | |
| the permissions of a user | does not have permission for | |
| when adding or modifying | it. | |
| them. | | |
| Everyone can change their | Creator can only specify the | Cannot add or remove a |
| own password. | user's administrative and | permission that one doesn't |
| | archive access control | have when modifying a user. |
| | permissions if they also have | |
| | the Can modify users | |
| | permission. | |

If there are permissions 119 that the creator 120 of the user does not possess, the secure data storage application 102 will not allow unauthorized permissions to be granted.

The following table describes each administrative access control operation option.

TABLE 4
Administrative access control options

| Permission | Operation description |
|---|---|
| Can add users | The new user can add users to the encrypted archive. |
| Can modify users | The new user can modify existing user permissions. |
| Can modify | The new user can specify an expiration date for |
| expiration | another user's access to the archive. |
| Can extend | The new user can add users who can create and |
| user permissions | modify other users. |
| Can extend | The new user can add users who can specify an |
| expiration | expiration date for other users' access to the archive. |
| permission | |

The ability to specify an expiration date is separate from all other functionality involved in modifying archive users. A user 122 might have permission to modify subsequent user information, but if they don't have the separate permission for modifying the other user's expiration date, they cannot change it when modifying that user's information.

With the Can modify users permissions, you can specify an expiration date for the new user's access to the encrypted archive 100. By default, there is no expiration date. If you choose to place a limit on how long the user can access the archive, you can use the Expiration section of the Add User dialog box of the application 116 to specify the date and time for the expiration. The new user automatically inherits the creator's archived individual file 110 and folders 112 permissions. When the new user is added, the creator 120 of the user 122 has the option to simply add the new user with the same permissions, or immediately view or change these permissions.

A user with the Can modify users permission, can modify most permissions for any user of the encrypted archive. With the Can modify users permission, one can:
Change the user's password and specify their administrative and overall archive access control options when modifying their permissions
Remove them as a user of the encrypted archive
View and update the archive contents folder and individual file permissions.

There are permissions 114 that the creator of a user cannot modify without other specific administrative access control permissions. For instance, one cannot change the expiration date for another user without the Can modify expiration permission, and one cannot give other users permission to add or modify other users without the Can extend user permissions permission. The latter can be used to limit downstream sharing.

In addition, the creator of a user 122 cannot give permission to a user 122 that the creator 120 of a user doesn't have himself/herself when modifying a user. For instance, if the creator of a user does not have permission to share archives, they cannot give a user this permission when adding or modifying them.

As long as the user's access to the encrypted archive 100 has not expired, they can always change their own password. The user does not need access control permission to change your password. In addition, a user can change another user's password if they have the Can modify users permission or are the Administrator user 120. Through the auditing feature, the Administrator user 120 can view all user passwords and users and can view the passwords of the users that they have added to the archive 100.

A user can remove a user from the encrypted archive if you have the Can modify users permission.

The archive access control 140 is used to determine the operations that users can perform to the encrypted archive 100 as a whole. These operation options are used when adding a user, if you have permission to modify user permissions, or when modifying a user. The archive access control operations are:
Can view contents—the user can view the encrypted archive files in the contents viewing, decryption, and permissions modifying dialog boxes.
Can add to archive—the user can encrypt archive files.
Can replace and delete—the user can replace archive files with newer copies and delete existing ones.
Can copy archive—the user can copy the archive to the hard drive.
Can share—the user can share archives by emailing them, copying them to local hard or networked drive locations or to removable storage media, and by adding encrypted Web content to removable storage media.
Allow decrypt and open—the user can decrypt, modify, and open archive files.
View with read-only viewer—the user can view archive files in a restricted read-only mode.

All of these permissions or operations, except for copying an archive, also apply to working with the archive contents on an individual file 110 or folder 112. With the appropriate permissions, a modifying user can override the user's overall archive permissions for folders and files.

The Add User and Modify User dialog boxes of the secure data storage application 116 provide the means to define the overall archive permissions for the user, as well as their administrative permissions. The same underlying principles involved in adding and modifying users apply to both types of permissions. For instance, for both types of access control, no user can modify their own permissions. Other shared or inheritance principles include: when adding or modifying other users, you cannot grant more liberal permissions than those you have yourself. However, you can restrict their permissions so that they have less extensive permissions than you have.

For instance, you might have permission to view the archive contents, encrypt additional files, and decrypt archive files, but not to copy the archive to a hard drive. When you add or modify another user, you might grant them permission to view the archive contents and add files to the archive, but cannot give them permission to copy the archive.

When the creator chooses the restricted viewing option for the user, they can provide additional security for the encrypted information. When you restrict files, for selected file types, the user can view the files, but not print, save, copy data from them, or modify them at all.

Archive Access Control Operations

The creator 120 with the Can modify users permission can specify the archive access control operations 142 for the user through the Archive Contents and Files sections of the Add/Modify User dialog boxes. The Archive Contents section consists of five options: Can view contents, Can add to archive, Can replace in archive, Can copy archive, and Can share.

All of the options can be overridden for specific folders or individual files. After a user has been created, these selections apply to all of the archive contents except for directories or individual files for which the creator had different permissions on the directory and individual file level. If you want these permissions to match the overall archive permissions, the directory and individual file level permissions must be modified separately to match them.

TABLE 5
Archive access control options

| Permission | Operation description |
|---|---|
| Can view | Can view the contents of the encrypted archive in the |
| contents | contents viewing, decryption, and permissions |
| | modifying dialog boxes. |
| Can add | Can add files to the encrypted archive. |
| to archive | |
| Can replace | Can replace and delete archive files. (The replacement |
| and delete | files that you encrypt from the hard or networked drive |
| | must have the same file names and locations as the |
| | original files) |
| Can copy | Can copy an archive on removable storage media to a |
| archive | local hard drive. |
| Can share | Can share archives by emailing them, copying them to |
| | local hard or networked drive locations or to removable |
| | storage media, and by adding encrypted Web content |
| | to removable storage media. |
| Allow decrypt | Can open files without restrictions and decrypt them. |
| and open | |
| View with | Can only view archive files in the restricted read-only |
| read-only | mode. |
| viewer | With this mode, the user can view certain types of |
| | restricted files with the read-only viewer. For more |
| | information on viewing restricted files, including the |
| | file types supported by the read-only viewer. |

The creator 120 uses archive contents access control 140 to specify the operations that users 122 can perform for particular files 110 and folders 112. The archive contents access control 140 can be used to override the permissions 119 that the user 122 has for the specified files 110 and folders 112. For instance, if the general archive permissions have granted permission to decrypt all archive contents 106 or the folder 112 that contains a particular file 110 might have that permission. However, if the decryption permission has been removed for that file 110 the user 122 will not be able to decrypt the file contents.

The creator 120 can also separately view the overall archive permissions 114, as well as those on the individual files and folders level, for all users. This feature provides a global view of users' permissions that enables you to quickly and easily identify your own or another user's permissions.

Unlike permissions for the overall archive, one cannot define the operation options for the archive contents 106 until after the user 122 has been created for the archive 100 and files 110 added to the archive. If a user 122 has the Can view contents and Can modify users permissions, they can modify the individual file and folder level permissions for other users.

Excluding the archive copying and sharing permissions, the content permissions for archive contents access control 140 are the same as those applied to the overall archive access control 142, but applied on the individual files and folders level. Following is a list of these archive contents access control 140 permissions:
Can view contents—the user can view the specified encrypted archive files, and open them.
Can decrypt/open—the user can decrypt the specified archive files and modify them. If the user does not have this permission, they can only view the files in restricted read-only mode.
Can add-when applied to a directory or folder, the user can add folders and files to it.
Can replace and delete—the user can delete or replace the specified archive files with newer copies.

All of the contents of files 110 and folders 112 have the same permissions as the file 110 or folder 112 that holds them unless the permissions are overridden for specific folders or files. If the permissions have never been modified for a user, all folders and files in the archive will have the same permissions as their overall archive permissions. If the permissions for an individual folder change, the permissions for all the sub-folders and files in the folder change accordingly.

The creator 120 can restrict access to the archive contents 106 so that the user 122 can only work with an individual file 110 or with the files 110 in a particular folder 112. For instance, although an encrypted archive 100 might contain all of the content 106 relevant to a transaction, you might want the finance department users to only work with the financial data for that particular transaction. In those circumstances, the creator would check the permissions that a finance department user has for the specific folder with the financial information files. The administrator 120 may give the finance department user viewing and decryption permissions for the folder and its files because they do not have general permission to decrypt or even view archive files. Further, while the head of the finance department might have access to all the financial information files, another department user might be restricted to certain files in that folder.

TABLE 6
Guidelines for using archive contents access control

| General | Specific |
|---|---|
| User initially has | Can assign different permissions for various |
| identical permissions as | individual directories and files. |
| creator for the | |
| individual directories/ | |
| files. | |
| Need modify permission | Cannot give permissions for a directory or |
| to change permissions for | files to which one doesn't have access. |
| other users on | |
| directory/file level. | |
| Cannot modify own | If the modifying user is restricted from |
| permissions. | viewing certain directories/individual files, |
| | they cannot view them for other users when |
| | modifying the permissions for those users. |
| Any user with the | Can add/restrict the permissions for other |
| permission to modify | users as long as one isn't giving them more |
| users has the ability to | liberal permissions to directories/files than |
| change the permissions | one has. |
| for all other archive | |
| users on the overall | |
| archive and directory/ | |
| individual file level. | |
| | When specifying different permissions for a |
| | particular directory, the same permissions |
| | automatically apply to all of the folders and |
| | individual files that the directory contains |
| | unless the permissions are changed |
| | individually. |
| | Even without permission to perform an |
| | operation for the archive, can give user that |
| | permission for specific directories/files if the |
| | user has permission to perform that |
| | operation for the archive. |
| | Can specify a directory or individual files and |
| | reset the permissions to those of parent |
| | directory, as long as resetting the |
| | permissions doesn't give the user more |
| | liberal permissions than one has to the |
| | directory or individual files. |

A user with the Can modify users permission can view overall archive and archive contents permissions for himself/herself and other users in summary form.

The Archive Permissions section of the View Permissions dialog box of the secure data storage application 116 lists the user's general permissions for the encrypted archive. The Content Permissions section of this dialog box lists the permissions for any specific folders and files that have different permissions than the overall archive permissions.

If a folder has different permissions, all of the folders and files it contains will be listed in this section with these changed permissions unless the overall archive permissions have been applied to them. The creator of a user can view a user's permissions immediately after they have added them to the archive by clicking View in the User Added dialog box. Folder and file level restrictions and permissions that apply to the user display in the View Permissions dialog box.

In addition to these basic functions, the application 116 permits the user to perform many other operations. Through the application Archive window, the user 122 can also:
With the access control feature:
   Add, modify, and remove other users, and specify their access to the archive and to specific archive contents
   Restrict the viewing of files (permission to view the files, but not to print, copy, or save them)
   Restrict the amount of time that other users can access the archive
Add encrypted Web content that automatically opens in a Web browser program to removable storage media
Share archives through email messages with a plug-in device
Share archives to removable storage media and any hard or networked drive locations with the media and hard drive sharing feature
Audit user and archive sharing information with the auditing feature

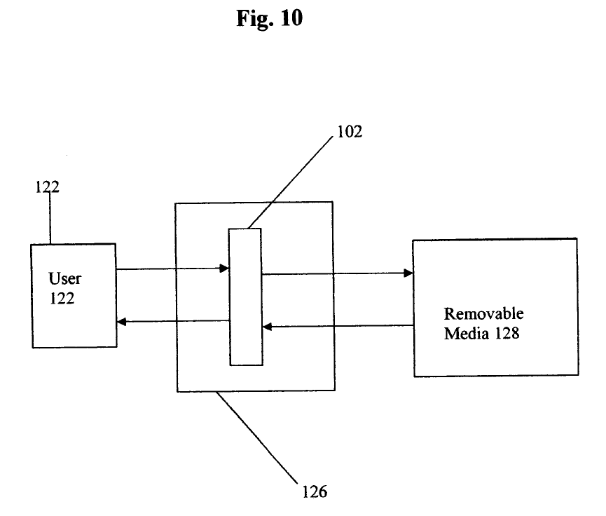

As shown in FIG. 10, for archives on removable storage media 128, the login dialog box automatically displays whenever you insert the media 128 in the drive of the electric appliance 126, as long as you have not disabled the Windows operating system auto-play functionality.

When attempting to access the archive 100, the user must login by entering their user name and password or providing an alternate identification method, such as a biometric or a digital certificate. After entering the login information, one can use secure data storage application 116 with the archive 100 without re-entering this information until the next time they wish to launch secure data storage application 116. With the auditing feature, the Administrator user 120 or the user 122 that added a subsequent user 222 to the archive 100 can retrieve user names and passwords (or other authentication method) for all users they have added to the archive 100.

To add encrypted files to the archive, the content provider 120 must:
1. Select the encryption option in the secure data storage application.
1. Choose the files and/or folders that you want to encrypt.
2. Copy the files and/or folders to the secure data storage application Archive.
3. Permanently add them to your encrypted files archive by encrypting the files and/or folders that you have copied.

If a folder with subfolders is selected to be encrypted, all of the contents of the folder, including the subfolders and their files, will be encrypted when you encrypt the folder.

After encrypted archive contains content, the content provider 120 can use the secure data storage application Archive window to view a list of the files. Each item listed includes the file name, as well as its size, most recent modification date, and your read, write, and overwrite permissions for it. You can use the contents viewing dialog box to open files, view restricted files, or to decrypt or delete files. By opening an encrypted file 110, you can view the contents because the application 116 automatically decrypts the files first. (If the file is restricted through the access control feature, when you open it, there will be limitations on how you can view it. Both the contents viewing and the decryption dialog boxes enable you to open files.

In most circumstances, you can only open one file at a time. However, if you open a file that is linked to associated files in the same directory or in sub-directories of the main directory, secure data storage application 116 will open all of the files, but only initially display the one that you have selected.

For instance, to view an HTML page that includes images, the image files must be accessible along with the HTML file. Provided that the same directory, or one or more of its sub-directories, contains HTML pages that are linked to the one that you have selected, you can access those files through clicking the relevant hyperlinks.

When applied, certain access control permissions restrict you from decrypting and conventionally viewing encrypted archive content 106. If you try to open a restricted file, if the file is one of a supported group of file types, you can view the contents 106 but not print, save, copy data from it, or modify it. If the restricted file is not one of these types, you will not be able to view it.

To view a restricted file, follow the same procedures that you conventionally use to open a file. The file will open in the secure data storage application viewer program, not the application that was used to create it.

After content 106 has been added to the archive 100, it can be decrypted directly from the encrypted archive. You can also decrypt files when you view a list of the archive contents.

When you decrypt a file, a decrypted copy of the file is sent to the directory that you have chosen, while the original encrypted file remains unchanged in the secure data storage application archive. If you are decrypting a file from an archive that you copied from removable storage media, the secure data storage application archive on the hard drive maintains an original copy of the file sent to you on the secure data storage application removable storage media unless you replace it later in the archive with a modified copy.

To replace a file in an encrypted archive, modify the file and then encrypt it from the same location on the hard drive from which you originally encrypted it.

When archive files are deleted, they are no longer visible or accessible to archive users. However, while secure data storage application blocks access, it does not eliminate them from the archive. In this way, previous versions can still be recovered as needed.

If you have the media plug-in, you can add the secure data storage solution 116 to a piece of removable storage media 128. Once this is done, you can use solution with any appropriate operating system, the appropriate compatible drive for the media, and compatible CD recording and reading software.

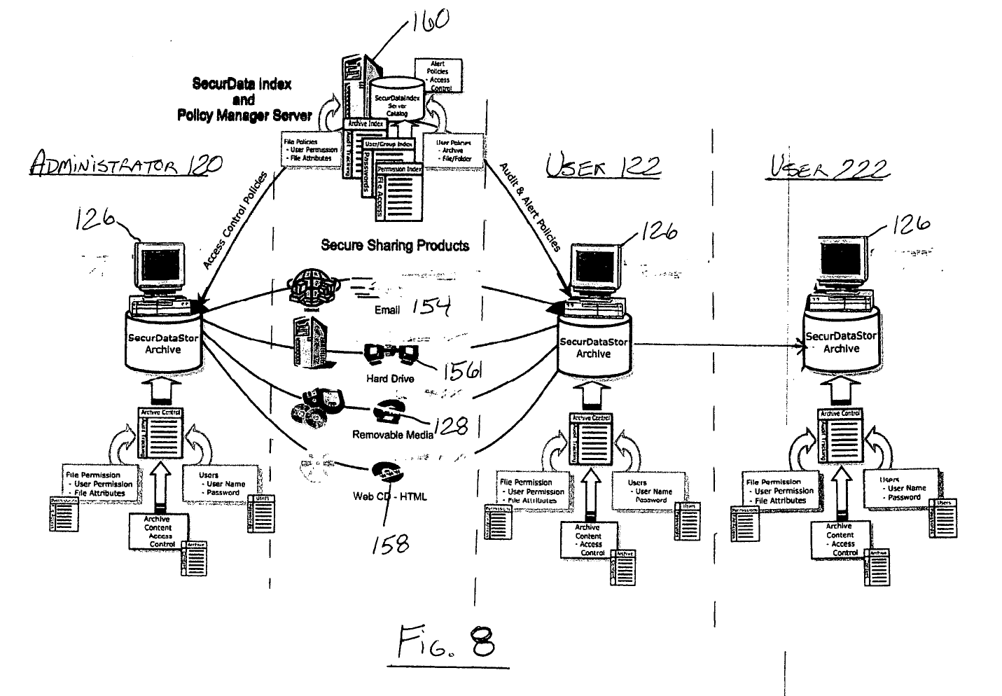

FIG. 8 shows that the secure data storage application 102 provides a means by which content providers 120 can create one or more archives 100. These archives 100 can be attached to an email message 154, created in a fixed-disk location 156 or on removable media 128 or on removable media with access through a web browser 158. The secure data store application 116 has the objectives of; 1) providing a user interface 130 allowing the user 122 to provide the information required to construct an archive 100; 2) constructing an archive 100 (accomplished using the API Library); 3) managing the feature set to which a user 122 has access based on license keys 131; and 4) copying the required fixed files (application files, help files and other required support files) to the archive location 100. Once the user has created the archive 100, they can add content 106 using the secure data store application 116.

The present invention is designed to address the security problems associated with removable storage media 128, such as floppy disks or CD-ROM discs. Removable storage media 128 is easily stolen or misplaced. The secure data storage application 116 for removable media can also be used as a plug-in to the basic secure data storage application 116, and is designed to ensure content 106 stored on such media 128 is protected if such removable media 128 is in fact stolen or misplaced. This small encryption application takes up minimal space on the media, supports variable key lengths in order to comply with US export restrictions, and based on testing conducted by the National Security Agency that is certified appropriate for commercial use.

Additionally, the present invention allows the user to create HTML content 106 on a secure data storage media. The secure data storage application 116 for web browsers automatically launches the client browser and after the user enters the correct password, or uses an appropriate alternate authentication mechanism, such as a biometric or a digital certification, they can navigate the contents of the disc. The HTML content 106 is decrypted on the fly and the user does not need to copy any of the content onto the hard drive of their appliance 126. This feature is especially useful for individuals that need access to web content 106 in an offline manner, yet that still protects the contents. Examples include field service technicians that require access to product manuals and diagnostic information that has been organized in a web directory format, workgroup files (e.g. Lotus Notes) or any type of information that is more easily navigated through a browser interface.

The present invention is also designed to provide a mechanism to encapsulate sensitive information for transmission as an email attachment (content 106) over the Internet, and to maintain the security of the archive and policy management scheme after it has been downloaded to the recipient's hard drive or file server 160. The secure data storage application 116 ensures that sensitive information that a user sends over the Internet is protected from attack and minimizes the potential impact of known email software security holes. Since each email attachment 106 is wrapped in a “protected and intelligent” envelope, the information contained in the email is itself uniquely protected, providing an additional layer of protection beyond browser based security software. After the email attachment is opened, secure data storage software automatically installs a protected archive of information on any system that the user specifies. The sender controls how long the information can be used and the permissions associated with accessing the information. Finally, an automatic email notification is sent to the sender, providing a “certified mail receipt” that informs the sender that the information was successfully received, is installed on the recipient's machine, and captures the machine name and where the information is stored.

One feature of the present invention functions as an active index and catalog. It tracks secure sharing from PC desktop to PC desktop, or to and from a file server. The secure data storage application 116 is essentially a Systems Security Officer/Administrator reporting tool that can be server based and that track where sensitive information is stored (either on the hard drive, the file server, or on removable media), with whom the information has been shared, and the access control policy associated with the information. Another feature of the present invention functions to provide audit tracing and reports on the sensitive information created, managed, used, and distributed by a business. The software will be capable of recording all I/O activity associated with sensitive business information, provide automatic alerts if sensitive information is not being effectively protected or if actions that violate access control policy are attempted by users, and will provide reports regarding the general status, use, access, and distribution of sensitive information by a business.

The application of the solution to web-viewing 158 allows the contents 106 of an archive 100 to be viewed though a web browser. The major components of this web viewing application are a Web Server, an interface code, and a user interface 130. The Web Server provides content as requested by a web browser.

A Reader application allows the user to read an archive 106 that has been packaged as an email attachment 154 (.pnx file). The Reader application is responsible for extracting the archive-specific files (content) from the attachment and adding the archive application files, (such as the secure data store application 116, help files and other required support files). These files are written to a location of the user's choice and an email message is sent to the archive originator informing the content provider 120 that the archive 100 has been received and the content 106 successfully extracted from the archive 100. A read-only viewer application 112 provides a means to view content where the user is not allowed interaction that would extract content, such as save, copy, or print.

Integrated within the application is the technology which provides a general product license key or product license 131 used to access the archive 100. The product license 131 provides a means for controlling operations on the content 106 maintained in the archive 100 by controlling user accessible features in the permission wrapper 108 and supports the product ID, the serial number, a feature bit-mask and the access expiration date. Associated with the product license 131 are counting keys, which keep track of the number of times the archive is placed on removable media 128 and the manner in which the content 106 is used. For example, the counting key may keep track of the number of times the content 106 is view, printed, or copied. The present invention also encodes the counting key so that it is coupled with the product license 131 to ensure a counting key cannot be used with a different product license 131 than the product license 131 supplied to a given user. In addition, the product license 131 is configured so that it can manage product transitions. Thus, the product license 131 defines the rules related to upgrading from one product to another product.

The product license 131 and counting key, must have persistent representation. This representation can take many forms, such as in a file, in the Windows registry, or in a server-based database. The product is architected to allow the persistence mechanism to be changed.

The counting key also has two persistent elements; the current count and the maximum count. The counting keys must be made independent of each other, but dependent on the product license key. In order to accomplish this, the counting key, product identifier, the product serial number and a numeric value are hashed to generate the counting key. The counting key must have the current count and the maximum count thereby necessitating the two persistent elements.

A user 122 can ask that secure data storage application 116 open a protected file using the appropriate third-party application 134. It does this by staging the clear copy of the file (or files) 110 then launching the appropriate application for the file. The secure data storage application 116 then requests whether or not the user would like to bring the changed file 110′ back into the archive 100 (assuming the user has overwrite permission for the file). The user's modifications are added as a new version of the file. This version control capabilities of the product ensures that the user can track the modifications to the files. Once the user 122 has completed their use of the file 110, secure data storage application cleans up the temporary file(s).

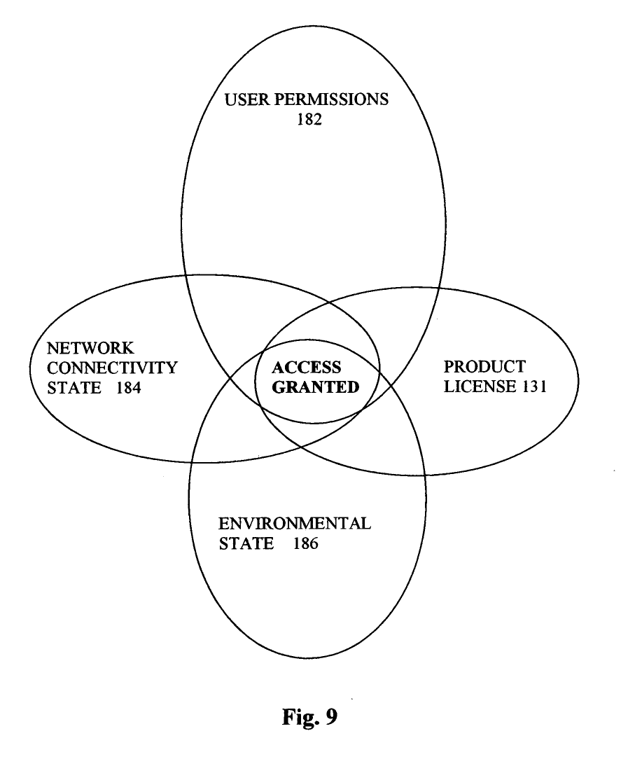

As shown is FIG. 9, the secure data storage application 116 is designed to have a number of predefined templates for new users. Initially these are Fully Trusted 170, Moderately Trusted 172, and Untrusted 174, though those skilled in the art understand that any number of different templates could be defined and used. In addition, these templates can be chosen when creating a new user and then redefined to reflect the specific access granted to the new user or to reflect a change in the operating environment. An enterprise user or user 122 may have their own ideas as to the default set of permissions they want to assign to a new user. Allowing a user to create and use their own templates reduces the repeated refining of permissions that is required each time a new user is added as well as reducing the chances of an error being made by making a mistake while refining the permissions.

Each template, 170, 172 and 174, provides a default set of archive-level permissions. It may be defined from the complete Add User or Modify User dialogs or alternatively, it may have its own dialog. Saving the settings records the following:
A template name
A template description
The archive-level permissions
Expiration time in terms of number of days (or never)

The templates 170, 172, and 174 are saved in a resource file that is external to the secure container 100. This resource file may be used for many archives and if it is on a network drive, it may be shared by multiple users. The user 122 must be able to specify the file in which the template will be stored. The secure data storage application software 116 will encrypt and record this file and use it for future template references.

There are two methods to grant a user 122 and/or secondary recipient 222 access to the archive 100.

As shown in FIG. 9, the creator 120 is only required to make a decision on the type of user to be created—Fully Trusted 170, Moderately Trusted 172 and Untrusted 174. User types are created with pre-defined templates for each organization and can be reviewed by clicking on the appropriate option within the secure data storage solution 116.
1. Fully Trusted users will have all available permissions;
2. Moderately Trusted users have Open/Save as privileges, but no Add/Modify, and no Share privileges;
3. Untrusted users will have Read-Only archive viewing permission, and have no archive administration permissions.

The second method allows the creator 120 to further define the permissions and privileges 119 that the new user 122 or 222 can be granted. The creator 120 of the archive 100 can specify specific the administrative and general archive access control options, 144 and 142 respectively. The following only presents information on setting the administrative access control options 144. After entering the user name and password (or other authentication mechanism), these options consist of: specifying administrative access control operations and possibly setting an expiration date for the user's access to the encrypted archive.

If an user has the Can modify users permission, they can specify the administrative access control operations 144 of the user 122 by selecting one of the three template user types 170, 172, or 174 as described above, or through the refined method of permission controls wherein the content provider can establish a user's permissions by designating any of the following permissions: Can add users, Can modify users, Can modify expiration, Can extend user permissions, and Can extend expiration permission.

Access Control Rights

A user's rights to view, manage, and share protected data is defined by the intersection of four different sets of permissions as shown in FIG. 9. Each set has as members the various access control rights.

The four permission sets are:
1. Permissions available based on the product license 131 held by the user.
2. Permissions available based on the permissions granted 182 to the user.
3. Permissions available based on the permissions available within the user's current network connectivity state 184 (locally connected, remotely connected, and not connected).
4. Permissions available based on the current threat model or environmental state 186 (safe, company under attack but current environment not under attack, and current environment under attack).

These permission sets are described below.

The user's current permissions are defined by the set-based intersection of the permissions available based on each of these categories.

Product License

The product license 131 defines a set of operations that are made available to the user. The following table shows three product offerings and the set of features that each provides:

| | | | | | | | Manage | |
|---|---|---|---|---|---|---|---|---|
| Access Control Rule/ | | Access | Create | Share | Share | Share | shared | |
| License Key Feature | Encrypt | control | SecurMedia | email | fixed disk | WebCD | resources | Audit |
| SecurDataStor Basic | ✓ | | ✓ | | | | | |
| SecurDataStor Premium | ✓ | ✓ | ✓ | ✓ | ✓ | | | |
| SecurDataStor Professional | ✓ | ✓ | ✓ | ✓ | ✓ | ✓ | ✓ | ✓ |

The following table relates the features provided by a product license and the archive permissions that can be made available to the user.

| | | | | | | | | Manage |
|---|---|---|---|---|---|---|---|---|
| Access Control Rule/ | No | | Access | Create | Share | Share | Share | shared |
| License Key Feature | license | Encrypt | control | SecurMedia | email | fixed disk | WebCD | resources |
| Can view contents | ✓ | | | | | | | |
| (files/folders) | | | | | | | | |
| Can add new content | | ✓ | | | | | | |
| Can replace or delete | | ✓ | | | | | | |
| existing content | | | | | | | | |
| Can open with application | ✓ | | | | | | | |
| or make a clear copy | | | | | | | | |
| Can make local copy of | ✓ | | | | | | | |
| archive | | | | | | | | |
| Can share | | | | ✓ | ✓ | ✓ | ✓ | |
| Can add a new user | | | ✓ | | | | | |
| Can modify an existing | | | ✓ | | | | | |
| user | | | | | | | | |
| Can modify a user's | | | ✓ | | | | | |
| expiration | | | | | | | | |
| Can give a user permission | | | ✓ | | | | | |
| to create or modify users | | | | | | | | |
| with the ability to further | | | | | | | | |
| create or modify users | | | | | | | | |
| Can give a user permission | | | ✓ | | | | | |
| to give other users the | | | | | | | | |
| ability to set expiration | | | | | | | | |
| permission | | | | | | | | |
| Can lock to machine | | | | | | | | ✓ |
| Can manage/use shared | | | | | | | | ✓ |
| resources | | | | | | | | |

Permissions Granted to User

The archive author and those designated by the archive author can grant a specific set of permissions 114 to a user 122. Each of the permissions can be independently granted. It is these permissions that reflect the content provider's intent as to how the user 122 or 222 is allowed to interact with the permission wrapper 108 and what the user 122 is allowed to do with the protected data.

These permissions can be individually specified, or collectively associated with a user using a template. Template examples include:

| Template | Purpose |
|---|---|
| Fully | This user is fully trusted by the individual who is creating |
| trusted | the user. As such, the user is granted all permissions that |
| | the creator is able to grant. |
| Moderately | This individual is trusted with the content that is being |
| trusted | protected but is not allowed to further share the content |
| Untrusted | This user is granted access to the material in a view-only |
| | manner and is given no other permissions with respect to |
| | the data. |
| No access | The user is not allowed to do anything with the content |

Additional templates can be defined by organizations to reflect their own trust models. Each template has as a component a set of permissions that define what an individual can do with the protected content.

Network Connectivity

Network connectivity 184 provides an indication of the level of trust that the author places on the environment associated with a user 122. The three network connectivity states are:

| State | Meaning |
|---|---|
| Locally | A locally connected user is typically though of as being in |
| connected | the office. These users are connected to the security server |
| | through a local network connection. |
| Remotely | A remotely connected user is typically thought of as being |
| connected | out of the office. This individual may be working from |
| | home or a client site. The user has access to the security |
| | server, perhaps through a SVPN or simply through an |
| | internet connection. |
| Not | A disconnected user is one who cannot communicate with |
| connected | the security server. They may have no network access at |
| | the time or the nature of their network connectivity doesn't |
| | allow for communication with the security server. |

Associated with each of these states is a set of permissions that define the maximum set of rights available to users within that connectivity model. Similar to the user permission templates, a template can be associated with a user for each of these network connectivity states.

Environmental Threats

The current safety of the environment in which the contents 106 of an archive 100 is being accessed can further limit the set of operations available to an archive user. The three recognized environmental states 186 are:

| Environment | Meaning |
|---|---|
| Safe | The current computing environment is regarded as being |
| | safe. There are no known threats to the company that |
| | warrant reducing individuals access to protected data. |
| Potential | There are parts of the company that are under attack but |
| threat | the computing segment of the user is not currently under |
| | attack. Because the company is under attack, the current |
| | computing environment is not considered as secure as |
| | desired. |
| Under | The segment of the company in which the current |
| attack | computing environment resides is under attack. Limits to |
| | access to secure data may be strongly limited to reduce the |
| | ability of those making the attack to gain unauthorized |
| | access. |

Associated with each of these states is a set of permissions that define the maximum set of rights available to users within that threat model. Similar to the user permission templates, a template can be associated with a user for each of these threat states.

### EXAMPLE

For example, consider only the user templates described above (trusted, moderately trusted, untrusted, and no access). It is desired to have a user 122 who has full access to content when the user 122 is able to communicate with the security server and the computing environment is safe. We want to limit access to view-only when the user is unable to communicate with the security server or there's a potential threat to the corporate computing infrastructure. Furthermore, it is desirable to provide no access at all if the user's current environment is under attack.

To accomplish this, we create the user 122 and logically associate with that user the following templates:

| State | Template |
|---|---|
| Locally connected | Fully trusted |
| Remotely connected | Fully trusted |
| Not connected | Untrusted |
| Safe environment | Fully trusted |
| Potential threat | Untrusted |
| Under attack | No access |

Consider the following scenarios:
The user's in the office using a machine on which secure data storage application 116 is installed. The machine can communicate with the Security Server 160 and the corporate computing infrastructure is deemed safe. In this case, the user has unrestricted access to the archive's contents 106 and has access to all archive operations. This is derived by intersecting the product license permissions 131, the user's permissions 182, the network state permissions 184, and the threat or environmental permissions 186. These are:
   All operations available based on product license key 131
   Fully trusted based on user permissions 182
   Fully trusted based on network connectivity 184
   Fully trusted based on threat state 186
The final permissions are based on the intersection of these permissions and gives full access.
The user's working at a client site. The machine 126 on which the user 122 is working has secure data storage application 116 installed. The user 122 does not have any communication available with the Security Server 160. In this case the user 122 will only have access to the protected content 106 in a view-only mode. This is derived from the permissions:
   All operations available based on product license key 131;
   Fully trusted based on user permissions 182;
   Untrusted based on network connectivity 184; and
The final permissions are based on the intersection of these permissions and gives view-only access to the protected content 106.
The user is working in the office and the segment of the computing infrastructure in which the user works is under attack. In this case the user 122 will have no access to any of the protected content 106. This is derived from the permissions:
   All operations available based on product license key 131;
   Fully trusted based on user permissions 182;
   Fully trusted based on network connectivity 184; and
   No access based on threat state 186.

The final permissions are based on the intersection of these permissions and no access is granted to the protected content 106. Thus, in all cases, the permission wrapper 108 has embedded security policies which are based on the intersection of least two of: the product license, user permission, network connectivity and environmental state.

The scenarios discussed are simple scenarios using only the predefined user permission templates. There is a great deal of flexibility provided in determining permissions based on simple set intersection. An organization can appropriate control access and manipulate of sensitive data by tailoring the way in which these permissions are associated with users.

In conclusion, the permission control wrapper maintains and provides user templates in common groups of permission control for different levels of trusted users. The permission control wrapper understands the current state of user network access. Permission controls are automatically modified to be either more or less restricted based on the recognition of whether or not the user is locally connected to the network, remotely connected to the network, or disconnected from the network. Furthermore, the permission control wrapper has embedded security control policies which are the rules by which the permission controls are enforced through the permission control wrapper 108. The policies describe the allowable set of permissions that a user is granted based on an embedded table that defines the policies for users based on the intersection of:
a. The user trust level as assigned by the Administrator of the archive, such as untrusted, moderately trusted, or fully trusted.
b. The network connectivity state of the user, such as connected, remotely connected and disconnected.
c. The license key controlled feature sets for the user, which provides access to features of the permission wrapper through the user interface.
d. Whether or not a binding or locking restriction is associated with the user.
e. If a threat has been detected on the user system on which the content is stored, the network segment that the user's machine is located, or if the pattern of the user behavior (e.g. attempted share operations for user without share permission) is considered to create a threat to the data protected by the software permission wrapper.

The permission control wrapper 108 is a fully independent security control mechanism. It is a self executing control mechanism that has the ability to understand threats to protected information maintained inside of the archive 100. Threat determination is based first on behavioral pattern recognition rules embedded in the permission wrapper control structure. Associated threat patterns that the permission wrapper 108 can independently recognize include failed multi-login attempts, attempts to circumvent archive and data locking controls, attempts to circumvent time expiration features, attempts at sharing protected files for users without sharing permissions, copy attempts for users without copy permission, and attempts to violate view read only permission control settings. Threat determination is also based on externally reported threats to the permission wrapper through a software communication protocol. External threats may include hacking attempts into the corporate network, virus attacks, denial of service attacks, and other externally manifested threats that may correspond to a threat to protected data. As threats are understood, either through embedded pattern recognition rules or through external threats reported through the communication protocol, the permission control wrapper can automatically change the policy rules for user access—making access more restricted. The permission control wrapper can perform this function automatically, without user intervention. The permission control wrapper can also lessen the security policy settings automatically, as the threat has determined to have passed. Such determination is made based on the communication protocol for externally reported threats, and a continued and repeated usage of the files in the permission control wrapper in accordance with the pre-specified permission control policies, for threats that initially exceeded pattern recognition threshold tolerances.

Content Provider Example

In addition to using the permission wrapper 108 as a standalone solution, it can easily be adopted to interact with a Content Authorization Server or server 160. As a result of this interaction, the secure container 100 must modify its behavior to apply the access policies specified by the server 160. Absent contact with the server 160, access to the archive is limited according to the rules specified by the content provider 120. The content provider can provide rules that specify how the application 102 behaves when access to the server 160 is not available. Examples of possible actions are: completely deny access to the archive's contents; allow access, but with reduced permissions (for example, restricting the set of visible content or restricting opening files to the view only reader. This is implemented by specifying an alternate user's permissions should be used when communications aren't available); or allow full access, which may be used if the content being conveyed to the server was for auditing purposes.

The communication channel between the secure container 100 and the Content Authorization server 160 will utilize the HTTPS protocol. This enables a secure channel using a protocol that will most likely be able to operate through a firewall.

An archive can be uniquely labeled, based on a Globally Unique Identifiers-GUID. When sharing an archive labeled this way, the archive can either be assigned a new GUID as well as track the history of the GUID for the parent archive. Each batch of archives created in this way could have the same GUID or different GUIDs.

A content provider 120 is likely not to have knowledge of the machines 126 on which their content will be utilized. However, if the server 160 is accessed, it can be used to make this association at the time of use. Therefore, mapping between the archive 100 and the machine 126 can be made and future decisions can be based on the archive user, archive label or machine label. A subscription charge that when paid, allows access for a given time period; a subscription charge that, when paid, allows a given number of accesses; and a per-use charge. A content provider 120 may want to collect information about how their content 106 is being used. The information that can be collected includes the login; logoff; files opened; sharing; and administration operations (such as adding users and such). Auditing usage requires the archive 100 maintain a conversation with the server or updating the server 160 the next time the archive is in communication with the server 160. Based on the audit information, a number of reports can be created by the server 160. Examples of these are:
Protected content. This report includes the archive's unique identifier, purpose, creation time, and number of copies that were made. Purpose and number of copies are information provided when the archive is shared.
Registration. This report includes information about the archive and who registered to use it including the user's unique machine identifier and any other information collected as part of the registration process.
Usage. Includes information about successful archive logins.
Sharing. Report on the unique identifier for the source archive and the new unique identifier for the shared archive and information about who did the share operation. This report includes the unique machine identifier and the archive user they logged in as.
Archive users. This report gives information about the permissions of archive users.
Possible security issues. This report gives information about failed logins or attempts to access archive functionality to which the user is not entitled (such as the audit users report).

Content access may also be restricted to certain time intervals such as, access is allowed up to given end date, access is allowed only after a given start date, or access is allowed only between a given start date and end date. The present invention also detects when a user sets their internal clock back in order to circumvent time limits on their access.

Additionally, the server 160 can be used to provide the current time. FIG. 10 shows the general use case for a user 122 who receives a removable media 128 from a content provider 120 who has used the application software 116 to protect their content 106. The user 122 wants to access the content 106 so they insert the removable media 128 into their system 126. The user 122 is challenged with use name and password. If they are valid and not expired, access permissions 114 are examined. If needed, the server 160 is contacted for authorization. The user's system 126 contacts the server 160 and sends the content id, machine label and archive. (using SSL). Stored within the server 160 are the authorized user information, authorized machine information, tracked archive labels, audit policy and policy rules if applicable. The server 160 can implement any policy with respect to authorization. In particular, it can perform a financial transaction prior to authorizing use of the content 106 by contacting an E-commerce server (not shown) which provides the underlying infrastructure for obtaining payment from a customer. In the present invention, the server 160 knows the content 106 within the archive 100 based on the archive label, the machine based on the machine label, and the level of rights being requested based on the login. In addition, a policy engine 162 can be provided to enforce any or all of the rules set forth above.

The secure content server 160 has several responsibilities. Primary amongst these is authorization, tracking and compensation. The server 160 has several subsystems that are involved in its implementation. The server 160 would also require a database engine (e.g., Oracle or Microsoft SQL Server) to manage a great deal of data including the archives 100 for which it provides authorization, the authorization policies, the auditing information, and compensation information.

The content provider 120 will need access to a number of reports which may cover the registered archives 100, the permissions 114 applied to the archives 100, the registered clients/users 112 and the archives 100 to which they have access, client usage of archives, possible attempts at security violations, and revenue.

The rules cover the permission policies specified by the content provider 120 as to the conditions around which access to the secure content 106 is granted. These rules cover pricing policy, and access policies. In particular, rules for the following are used:
whether access is allowed without first reauthorization from the server.
frequency of the reauthorization.
the time interval in which access is granted.
pricing rules covering the kind of rates associated with usage or linkage to ecommerce engine items

The secure content authorization server 160 allows the content provider 120 to apply more sophisticated logic around granting access to their content 106. For example, a content provider may expect compensation for use of the provided content 106. Several payment models are possible, such as, a onetime charge after which access to the specific archive on a specific machine is fully authorized without further communication with respect to payment with the secure content authorization server 160.

1. A system for sharing with multiple users and protecting content in the form of digital information from unauthorized access and/or use comprising:
a) content to be shared and protected; and
b) a permission wrapper having the ability to independently change the level of access to the content.

2. A server-less system for sharing and protecting content in the form of digital information from unauthorized access and/use comprising:
a. content to be shared and protected; and
b. a permission wrapper having the ability to independently change the level of access to the content.

3. The system according to claim 1, wherein the permission wrapper includes embedded audit logs.

4. The system according to claim 1, wherein the permission wrapper include audit logs which maintain a history of the access and initial use (i.e. viewed, printed, shared, etc.) to the content.

5. The system according to claim 1, wherein the permission wrapper collects information on who, when, where and what the user did with the content.

6. The system according to claim 1, wherein the permission wrapper tracks version control of the content.

7. The system according to claim 1, wherein the permission wrapper includes embedded controls for controlling the use and sharing of the digital information content.

8. The system according to claim 1, wherein the permission wrapper includes embedded controls containing inheritance rules which limit access to the content as defined by the original content provider.

9. The system according to claim 1, wherein the embedded controls include multi-level permission controls.

10. The system according to claim 1, wherein the embedded controls can provide different access to the content by a designated class of users.

11. The system according to claim 1, wherein the permission wrapper includes embedded controls which fix the access to the content to a specific device or set of devices.

12. The system according to claim 1 wherein the content is encrypted.

13. The system according to claim 1, wherein the permission wrapper includes embedded controls which limit the time frame in which the user can access the content.

14. A digital information security system for creating, archiving, transmitting and controlling archive content comprising:
a. a first system on which content is created;
b. an archive including a permission wrapper having access controls and the content stored therein;
c. means for transmitting the archive to a second system; and
d. means for controlling the access and/or use of the content independent of the means for transmitting.

15. A method for controlling the access to and/or use of content in the form of digital information comprising the steps of:
a. creating content;
b. creating a permission wrapper which controls access to and/or use of the content;
c. placing the content and the permission wrapper into an archive;
d. sending, by an original content provider, the archive to a first receiver;
e. controlling, by the original content provider, the first receiver's access to and/or use of the permission wrapped content;
f. sending, by the first receiver, the archive to a second receiver;
g. controlling, by the original content provider, the second receiver's access to and/or use of the permission wrapped content, wherein the control to the access and/or use by the second receiver is determined at the time the permission wrapper is created.

16. A server-less method for controlling the access to and/or use of content in the form of digital information comprising the steps of:
a. creating content;
b. transferring the content into an archive;
c. establishing varying levels of permission with respect to access to the content.

17. A secure container comprising content in the form of digital information and a permission wrapper having the ability to independently recognize threat levels.

18. A content protected permission wrapper comprising a variable portion which can adjust the permissions based on inputs from within the permission wrapper itself.

19. A secure content container including: content to be access and shared based on a content provider's permissions; an application capable of rendering the content; and a permission wrapper which can change its level of access based on input from outside the container.

20. A permission control wrapper which is used to protect digital information comprising:
a. a means for creating an archive on any type of digital medium;
b. a means for assigning digital content to said archive;
c. a means for assigning users their rights and access control permissions to said archive; and
d. a means for controlling user operations on said archive based on a license key that controls user accessible features of the permission wrapper.

21. A permission control wrapper as recited in claim 20 further including a means for securely sharing content maintained in the archive to other users through email, on file servers and hard drives, and PC removable storage media.

22. A permission control wrapper as recited in claim 20 further including a means for maintaining version control and synchronizing protected files and folders internal to archives and external with archives shared with other users.

23. A permission control wrapper as recited in claim 20 further including a means of auditing user activity associated with the creation, sharing and use of files and folders protected in the archive.

24. A permission control wrapper as recited in claim 20 further including a means of automatically changing the protection and permission controls of the archive based on associated threats to the data maintained inside.

25. A permission control wrapper as recited in claim 20 wherein means for assigning include a means for saving and storing these user rights and access control permissions into common templates.

26. A permission control wrapper as recited in claim 20 wherein said means for controlling include a means for automatically determining the protection requirements for said archive based on network connectivity state

27. The permission control wrapper as recited in claim 20, which can be used to assign files to it computer operating system specific file operation commands, such as cut, paste, drag, drop, save as, and send to.

28. The permission control wrapper as recited in claim 20, wherein the permission wrapper has the ability to hide the files and folders contained therein.

29. The permission control wrapper as recited in claim 20, which can be used to provide permission control over all types of digital information, including: movie files, spreadsheets, music files, word processing files, database files, other types of entertainment content, presentations, and any other type of information that is stored in digital form.

30. The permission control wrapper as recited in claim 20, which provides permission control features for assigning user access to files.

31. The permission control wrapper as recited in claim 20, wherein the rights and access control permissions includes the ability to expire user access to content after a specific time interval or at a specific point in time.

32. The permission control wrapper as recited in claim 20, wherein the rights and access control permissions includes the ability to change or modify files and folders maintained in the permission control wrapper.

33. The permission control wrapper as recited in claim 20 wherein the rights and access control permissions includes the ability to add files and folders to the permission control wrapper.

34. The permission control wrapper as recited in claim 20 which maintains and provides user templates in common groups of permission control for different levels of trusted users.

35. The permission control wrapper as recited in claim 20 has embedded control features that provide the user with access to the content and the ability to perform operations on the protected content through a user interface, which control features are managed through a software license key that automatically allows or disallows user access to user interface control features that manage access to the archive.

36. The permission control wrapper as recited in claim 20, wherein the user interface features controlled through the license key include user operations, which provides the ability to assign users to the content in the archive, and assigning those users their individual or group permission controls.

37. The permission control wrapper as recited in claim 20, wherein the user interface features controlled through the license key include user operations, which include sharing operations, which provides the ability of the user to share content maintained in the archive through protected email, on all types of computer removable storage media, on hard drives and on file servers.

38. The permission control wrapper as recited in claim 20, wherein the user interface features controlled through the license key include user operations, which include encryption operations, which provides the ability of the user to add files and folders to the permission wrapper in an encrypted form.

39. The permission control wrapper as recited in claim 20, wherein the user interface features controlled through the license key include user operations, which include decryption operations, which provide the ability of the user to decrypt files from the archive and store them outside of the archive on all types of digital storage media, such as hard drives, computer removable storage media, disk arrays, etc.

40. The permission control wrapper as recited in claim 20, wherein the user interface features controlled through the license key include user operations, which include audit operations, which provide the ability to recover user names and passwords, and access an event log of information maintained for the permission wrapper that tracks which users have access to the content, the type of access they are granted, when they were granted access to the content, on what devices are they allowed to access the content, the users that they in turn shared content with, and what operations the users have performed on protected files and folders maintained in the archive.

41. The permission control wrapper as recited in claim 20, wherein the user interface features controlled through the license key include user operations, which include locking operations, which provide the ability to lock or fix the content in the archive to a machine, device or related group of machines and devices.

42. The permission control wrapper as recited in claim 20, wherein the user interface features controlled through the license key include user operations, which include synchronization operations, which provide the ability to version control, update and synchronize files and folders with new information, and in turn to share those updates to other users that also have been granted access to the content through sharing operations.

43. The permission control wrapper as recited in claim 20, wherein the user interface features controlled through the license key include user operations, which include view operations, which provide the ability to see the files and folders stored in the archive.

44. The permission control wrapper as recited in claim 20, further including a means for securely sharing content maintained in the archive with other users through email, PDAs, instant messaging, on file servers and hard drives and PC removable storage media which provides users with secure sharing methods controlled functionally by the permission wrapper, and accessed through the user interface, which secure sharing methods ensure that the information remains in protected form not only during the actual sharing operation, but also when the content is installed and in use on a recipient's electric appliance.

45. The permission control wrapper as recited in claim 20, which maintains version history of when files and folders have been added to the archive including all the repeat versions of files wherein the recognition of the latest version is based on the date stamp of the file assigned by the operating system.

46. The permission control wrapper as recited in claim 20 which further includes an incremental update feature is provided by which a user may share only new or changed files with users that have access to protected files in the archive, said incremental update feature allows the user to only send the changed files, rather than all of the files in the archive.

47. The permission control wrapper as recited in claim 20 which further includes a synchronization feature which a user may notify other users of shared archives that a file or folder has changed, and those users may in turn receive only the updated or changed files or folders for shared content protected on their machines.

48. A permission control wrapper within an archive having protected content therein comprising a means for providing user access to the content in the archive based on embedded security policies.

49. The permission control wrapper as claimed in claim 48 wherein said means for providing user access includes at least two of (i) a user permission model, (ii) a licensed feature set, (iii) a threat model and (iv) network connectivity state; and a means for recognizing the intersection of those items present in said means for providing.

50. A permission control wrapper which is used to protect digital information contained comprising:
a. a means for creating an archive on any type of digital medium;
b. a means for placing digital content into said archive;
c. a means for assigning users their rights and access control permissions to said archive;
d. a means for controlling user operations on said archive based on a license key that controls user accessible features of the permission wrapper; and
e. a means for securely sharing content maintained in the archive with other users through a removable storage or digital media.

51. A permission control wrapper associated with an archive having protected content therein comprising a means of accessing the protected content through multiple access methods including a graphical user interface, a batch or command line interface, and an application programming interface.

52. A permission control wrapper associated with an archive having protected content therein comprising means for hiding from a user at least a portion of the content inside the archive, such portions cannot be directly executable upon by the direct operating system and application commands.

53. A permission control wrapper which is used to protect digital information comprising: a means for creating an archive on any type of digital medium including PD hard drives, file server drives, disk arrays, Personal Digital Assistants (PDAs), recordable and rewritable CD and DVDs, Zip drives, tape storage devices, and all other types of computer medium that can be written to; a means for assigning digital content to said archive; a means for assigning users their rights and access control permissions to said archive; and a means for controlling user operations on said archive based on a license key that controls user accessible features of the permission wrapper.

54. A system for controlling the access and/or use of protected content comprising a permission control wrapper including embedded security control policies, which policies are the rules by which the permission controls are enforced through the permission control wrapper, said policies describe the allowable set of permissions that a user is granted based on an embedded table that defines the policies for users.

55. The system according to claim 54 further including a means for enforcing said permissions based on the intersection of: a) the user trust level as assigned by the Administrator of the archive, b) the network connectivity state of the user, c) the license key controlled feature sets for the user, which provides access to features of the permission wrapper through the user interface, d) whether or not a binding or locking restriction is associated with the user and e) if a threat has been detected on the user system on which the content is stored, the network segment that the user's machine is located, or the pattern of the user behavior.

56. A system for controlling the access and use of protected content comprising a permission control wrapper that has the ability to understand the current state of user network access and automatically modifies the permission controls to be either more or less restricted based on the recognition of whether or not the user is locally connected to the network, remotely connected to the network, or disconnected from the network.
